(19) United States
(12) Patent Application Publication
(10) Pub. No.: US 2007/0211019 A1
(43) Pub. Date: Sep. 13, 2007

(54) ELECTRO-OPTICAL SUSPENDED PARTICLE CELL COMPRISING TWO KINDS OF ANISOMETRIC PARTICLES WITH DIFFERENT OPTICAL AND ELECTROMECHANICAL PROPERTIES

(75) Inventors: Nynke Anne Martine Verhaegh, Eindhoven (NL); Dick De Boer, Eindhoven (NL); Mark Thomas Johnson, Eindhoven (NL); Bas Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,302

(22) PCT Filed: Jul. 21, 2005
(86) PCT No.: PCT/IB05/52457

§ 371 Date: Feb. 6, 2007

(30) Foreign Application Priority Data
Aug. 9, 2004 (EP) 04103821.7

(51) Int. Cl. G02F 1/17; G09G 3/34

(52) U.S. Cl. 345/107; 359/296

(57) ABSTRACT

An electro-optical suspended particle cell comprises a liquid acting as a suspending medium. First particles (3) and second particles (4), which are anisometrically shaped, are dispersed in the liquid and have different optical properties. A driver is coupled between electrodes for generating an electrical field in the cell. The first particles (3) and the second particles (4) have at least one further different property to obtain different amounts of rotation of the first particles (3) and the second particles (4) as a function of a strength of the electrical field, or as a function of a duration the electrical field (E) is applied.

The invention relates to an electro-optical suspended particle cell, an electro-optical suspended particle device comprising a plurality of the electro-optical suspended particle cells, a light valve comprising the electro-optical suspended particle cell or device, a matrix display comprising the light valve, and a method of operating an electro-optical suspended particle cell.

U.S. Pat. No. 5,650,872 discloses an electro-optical device, such as a light valve, which has a cell formed of opposed cell walls and a light-modulating unit comprising a suspension containing anisometric particles suspended in a liquid suspending medium between the cell walls. The cell has opposed electrodes operatively associated with the cell walls for applying an electrical field across the suspension. In the absence of an applied electrical field, the particles in the liquid light valve suspension exhibits random Brownian movement, and hence a beam of light passing into the cell is reflected, transmitted or absorbed, depending upon the nature and concentration of the particles and the energy content of the light. When an electrical field is applied through the liquid light valve suspension in the light valve, the particles become aligned and the optical state of the of the cell changes.

Such light valves have been proposed for many purposes including alphanumeric displays, television displays, windows, mirrors, eyeglasses and the like to control the amount of light passing therethrough. The term liquid light valve suspension means a liquid suspending medium in which a plurality of small anisometrically shaped particles is dispersed. The anisometric shape facilitates orientation in an electrical or magnetical field and thus the change of the optical state of the cell.

A drawback of this known electro-optical light valve is that only a limited number of deterministic optical states is possible.

It is an object of the invention to provide an electro-optical suspended particle device with an increased number of deterministic optical states.

A first aspect of the invention provides an electro-optical suspended particle cell as claimed in claim 1. A second aspect of the invention provides an electro-optical suspended particle device as claimed in claim 11. A third aspect of the invention provides a light valve as claimed in claim 12. A fourth aspect of the invention provides a matrix display comprising the light valve as claimed in claim 13. A fifth aspect of the invention provides a method of operating an electro-optical suspended particle cell as claimed in claim 14. A driver for an electro-optical suspended particle cell as claimed in claim 15. Advantageous embodiments are defined in the dependent claims.

The electro-optical suspended particle cell in accordance with the first aspect of the invention comprises a liquid which acts as a suspending medium. First and second particles are both anisometrically shaped, and are both dispersed in the liquid suspending medium. Electrodes are associated with the cell, and a driver is coupled between the electrodes to generate an electrical field in the cell. If the electric field has a sufficient high strength or is applied for a sufficiently long time, one of the, or both the first and second particles rotate. The first and second particles have different optical properties. Thus, a different amount of rotation of the different types of particles causes a different optical state of the cell. The amount of rotation and ultimately an alignment of the first particles and the second particles with the electrical field occurs at different strengths of the electrical field, or at different durations during which the electrical field with a particular strength is applied. The influence of the electrical field is different for the different particles because the particles have a further property which is different.

Thus, the driver supplies different voltages to the electrodes to generate different electrical field strengths in the cell, or the driver supplies the same voltages during different periods in time, to obtain different optical states of the cell. Combinations are of course also possible. Because the different first and second particles align at different strengths of the electrical field or at different durations the same field is applied, different deterministic optical states are possible. For example, these deterministic optical states comprise at least a state wherein both the first and the second particles are not aligned, a state wherein at least one of the first and second particles is aligned, and a state wherein the other one of the first and second particles is aligned or wherein both the first and the second particles are aligned. As the optical effect of the first and second particles is different at least three different deterministic optical effects can be reached. Consequently, more optical states are possible than with a single particle with a single optical effect. The optical effect may be a reflection or absorption of a part of the spectrum or a polarization. A different reflection or absorption is noticed as a difference of the color of the light. The optical effect is referred to as deterministic because it is reproducible by applying a particular electrical field strength with respect to the different thresholds at which the different particles start rotating. Alternatively, a particular electrical field strength is applied during different periods in time to rotate only one of the particles over different predetermined angles, or to rotate both particles but over different angles. These different angles are different for different durations of the periods in time the field is applied. The deterministic optical effect has to be distinguished from temporarily intermediate optical states which occur when the cell changes from one deterministic optical state to another one. However, it has to be noted that, due to the bi-stable nature of the cell, if the two different particles rotate at a particular field strength at different rates, it is possible to make stable “intermediate” optical states. The deterministic optical states are also referred to as the aligned optical states because they occur when the particles are aligned by the presence of an electrical field.

In an embodiment as claimed in claim 2, the influence of the electrical field is different for the different particles because the particles have different masses, different dimensions, or different polarizabilities. Heavier particles tend to be aligned slower because they will rotate slower. Particles with large dimensions may have induced dipoles with relatively long dimensions, the moment caused by a particular strength of the electrical field is relatively large, and these particles will rotate relatively fast. If the polarizability of the particles is high, thus a large dipole will be induced, or the dipole is induced relatively fast, the rotational forces will be large and thus these particles will rotate relatively fast.

In an embodiment as claimed in claim 3, the electrical field is a static field. A static field minimizes the losses due to capacitive and other parasitic effects.

In an embodiment as claimed in claim 4, the electrical field is a homogenous field. In such a homogenous field no translational forces are generated on the particles which should be compensated for.

In an embodiment as claimed in claim 5 the first particles are aligned at a lower electrical field strength than the second particles, three possible deterministic states of the cell exist. In a first state, at relatively low field strengths, both the first and the second particles are not aligned. With not aligned is meant that the particles are in a disordered state due to thermal or so-called Brownian motion. In the third state, at relatively high field strengths, both the first and the second particles are aligned. In the second state, at intermediate field strengths only the first particles are aligned, and the second particles are not aligned.

This is elucidated with respect to the following example wherein it is assumed that the first particles reflect blue light and the second particles reflect red light, that if the particles are aligned they are aligned in the direction of the impinging light, and that no color filters or a colored suspending medium is present. In this example, in the first state the light reflected by the cell is magenta (red/blue) colored, in the second state the reflected light is red, and in the third state no light is reflected.

In an embodiment as claimed in claim 6, the cell has further electrodes which when a voltage is supplied to these further electrodes generate a further electric field which has an second orientation different than the first orientation of the first mentioned electric field. This has the advantage that the particles can change quickly between two different alignment states. It is not required to wait until the Brownian motion changed the orientation of the particles to the disordered state to obtain another optical state than in the aligned state. Preferably, to reach the largest difference between the two aligned optical states the first and second orientation are mutually perpendicular as defined in the embodiment as claimed in claim 4. The non-pre-published patent application in accordance to applicants docket referred to as PHGB030161GBP which has been filed as GB application 0322230.4 discloses such a construction of the cell and how to drive this cell.

In an embodiment as defined in claim 8; the electrodes are present at opposite sides of the liquid and each are separated into a plurality of displaced sub-electrodes. In such a geometry of the electrodes it is possible to generate electrical fields which are in parallel, perpendicular to, or are slanted with respect to the first and second support members. The patent application in accordance to applicants docket referred to as PHGB040008GBP which has been filed as GB application 0400289.5 discloses such a geometry of the electrodes and possible resulting orientations of the electrical fields generated. This geometry of the electrodes has the advantage that a further optical state of the cell can be reached in which the particles are aligned.

In an embodiment as defined in claim 9, the first and second particles have different colors. With different colors is meant different colors perceived by a viewer. This may mean that the spectrum of one of the colors covers the spectrum of the other color. For example, the first particles may reflect white light while the second particles reflect red light only. The different colors may also be associated with non-overlapping or party overlapping spectrums. With spectrum is meant a range of wavelengths of the light.

In an embodiment as defined in claim 10, the first particles are reflective for light having the first color and the second particles absorb light of a second color which is different than the first color. The amount of absorption need not be complete. For example, if the first particles reflect white light and the second particles absorb red light, starting with white light impinging on the cell, the reflected light is cyan if the first particles are aligned to reflect the impinging light. Preferably, the second color should lie within the spectrum of first color.

These and other aspects of the invention are apparent from and will be elucidated with reference to the embodiments described hereinafter.

In the drawings:

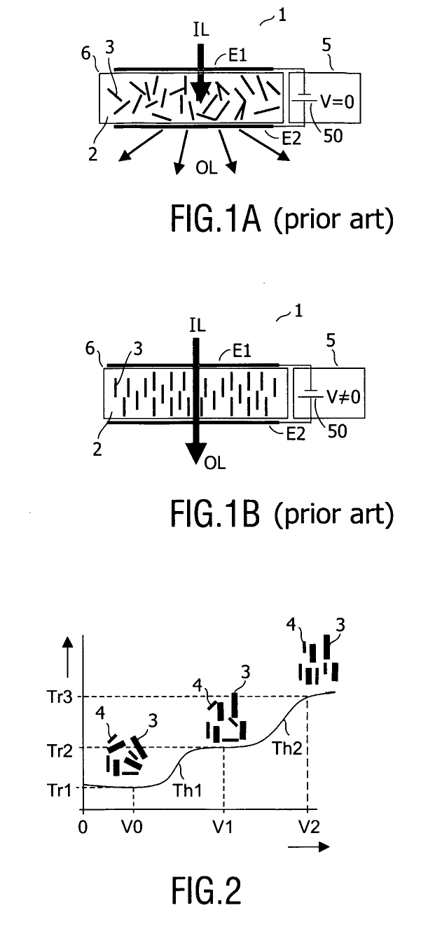

FIGS. 1A-1B show a schematic view of a prior art electro-optical suspended particle cell which comprises a single particle type,

FIG. 2 shows a sketch of the optical transmission of a cell which comprises two different particle types of which the orientation depends on the strength of the electrical field applied,

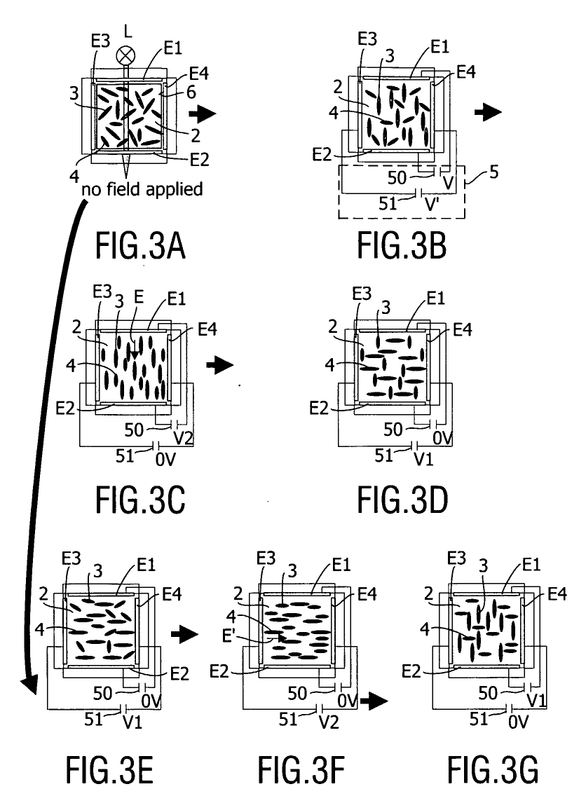

FIGS. 3A-3G show different alignment states of the two different particle types in the cell,

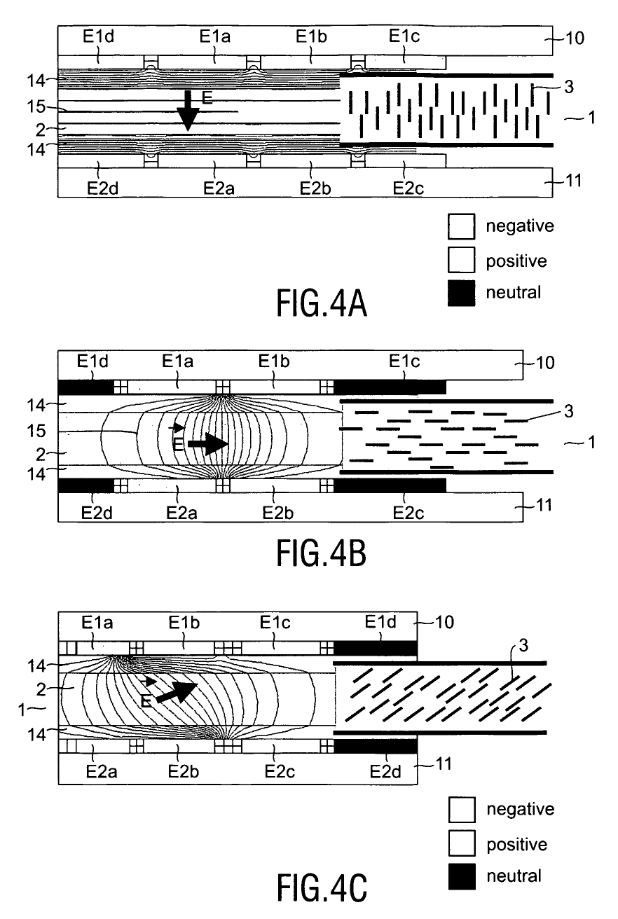

FIGS. 4A-4C show a cell construction in which more than two alignment directions of the particles are possible,

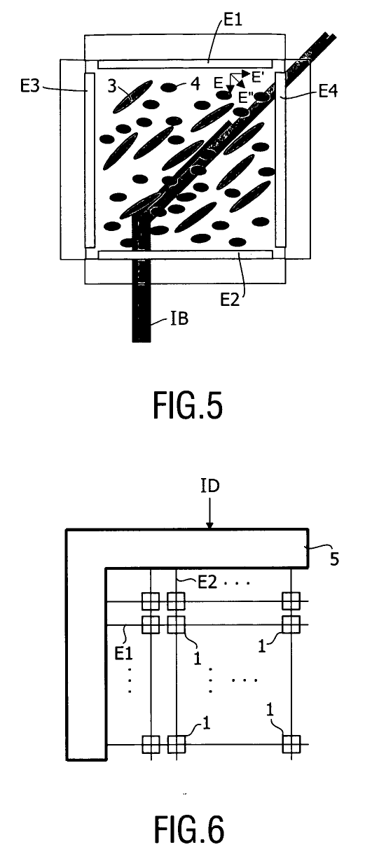

FIG. 5 shows a cell in which the first type of particles absorbs part of the spectrum, and the second type of particles reflect another part of the spectrum, and

FIG. 6 shows a matrix of cells forming a light valve cooperating with a matrix display.

FIGS. 1A-1B show a schematic view of a prior art electro-optical suspended particle cell which comprises a single particle type. Both in FIG. 1A and FIG. 1B, the cell 1 comprises a volume 6 in which the particles 3 are suspended in a liquid 2. The volume 6 is arranged between the electrodes E1 and E2. A driver 5 comprises a voltage source 50 which supplies a voltage V between the electrodes E1 and E2. In FIG. 1A, the voltage source 50 supplies the same potential to both the electrodes E1 and E2 (V=0V). There is no electric field E in the volume 6 and the particles are in a disordered stage due to the Brownian motion. In FIG. 1B, the voltage source 50 supplies a non-zero voltage V to the electrodes E1 and E2 to obtain an electric field E in the volume 6. This electrical field E induces a dipole in the anisometrically shaped particles 3 causing a torque acting on the particles 3. If this torque is sufficiently large and overrules the Brownian motion, the particles are aligned with the electrical field E as shown in FIG. 1B.

The optical state of the cell 1 shown in FIG. 1A and the optical state of the cell 1 shown in FIG. 1B differ because the particles 3 are in a disordered and an aligned state, respectively. For example, as shown in FIGS. 1, if the particles 3 are reflective, in the disordered state of the particles 3, the incident light beam IL will be scattered as is depicted be the plurality of outgoing light beams OL. In the aligned state the incident light beam IL is able to substantially pass the cell 1 which now appears transparent.

FIG. 2 shows a sketch of the optical transmission of a cell which comprises two different particle types 3 and 4 of which the orientation depends on the strength of the electrical field E applied. The strength of the electrical field E applied to the particles 3 and 4 is determined by the voltage V between the electrodes E1, E2. The voltage V is depicted along the horizontal axis, the transmission Tr of the cell 1 is depicted along the vertical axis. Below the threshold voltage Th1, for example at the voltage V0, both the particles 3 and 4 are non-aligned with the electric field E because the Brownian motion overrides the torque on the particles 3 and 4 caused by the relatively weak electric field E. The non-alignment of the particles 3 and 4 is illustrated in FIG. 2 above the voltage V0. Above the threshold voltage Th2, for example at the voltage V2 both the particles 3 and 4 are aligned because the torque caused by the relatively strong electric field E overrides the Brownian motion. In-between the threshold voltages Th1 and Th2, for example at the voltage V1, one of the particles 3, 4 is aligned with the electric field E, while the other one of the particles 3, 4 is not. In the example shown in FIG. 2, the particles 3 are aligned while the particles 4 have a (substantially) random orientation. Thus, three different optical states of the cell 1 with the transmission Tr1, Tr2 and Tr3 are obtainable by applying three different voltages V0, V1, V2 to the cell 1.

For example, if the particles 3 reflect blue light and the particles 4 reflect red light, the cell 1 reflects both blue and red light, only red light, and no light if the voltage supplied is respectively, V0, V1, and V2. If the light transmitted through the cell 1 is considered, and the particles 3 and 4 absorb blue and red light, the transmitted light will have the colors, green, cyan, and white, respectively. Of course, the particles 3, 4 may reflect or absorb other parts of the spectrum. Alternatively, one of the particles 3, 4 may reflect a part of the spectrum while the other one of the particles 3, 4 absorbs a part of the spectrum.

Optionally, the cell may further comprise a color filter in the form of a color filter element, colored liquid or a colored reflector.

FIGS. 3A-3G show different alignment states of the two different particle types in the cell. Now, the cell 1 comprises two groups of two electrodes. The first group of electrodes E1, E2 generates an electrical field E with a first orientation which in the example shown is the vertical direction. The second group of electrodes E3, E4 generates an electrical field E′ with a second orientation which is perpendicular with respect to the first orientation. Alternatively, the orientation of the electrical fields E and E′ may have another angle than 90 degrees. In all the FIGS. 3A-3G, the cell 1 comprises again the cell volume 6 which comprises the two different particles 3 and 4 suspended in a solution 2. The particles 3 and 4 have different optical properties and have at least one other property different. The other property is selected to obtain particles 3 and 4 which behave differently to the electric field E, E′ applied.

For example, as is shown in FIGS. 3A-3G, the elongated particles 3, 4 have different dimensions. The same electrical field E, E′ causes different torques on the different particles 3, 4 because the distance between the positive and negative charges induced in the particles 3, 4 differs. Consequently, the amount of rotation and alignment of the particles due to the same electrical field E, E′ may differ dependent on the strength of the electrical field E, E′ applied.

Alternatively, or also, the particles 3, 4 may have different masses, and/or different polarizabilities. A heavier particle will be rotated more slowly at a given electrical field strength. At a same electrical field strength, a larger torque will be exerted on a particle with a stronger polarizability.

Alternatively, instead of controlling the different orientations of the particles 3, 4 with different electrical field strengths, it is also possible to control the amount of rotation of the particles with the duration a particular electrical field strength is applied. For example, at the same electrical field strength, a larger particle may rotate over a larger angle.

In FIG. 3A, a light source L is shown which throws a light beam on the cell 1. No voltage difference is present between the electrodes E1, E2, E3, E4 and both the particles 3 and 4 have random orientations due to the Brownian motion. The impinging light beam will be maximally scattered if the particles 3, 4 are reflective, or will be absorbed if the particles are absorbing.

In FIGS. 3B to 3G the light source, although present is not shown anymore, while a driver 5 is added. The driver 5 comprises a voltage source 50 which supplies a voltage V between the electrodes E1 and E2, and a voltage source 51 which supplies a voltage V′ between the electrodes E3 and E4.

In FIG. 3B, the voltage V′ is selected below the threshold voltage Th1, and the voltage V is selected above the threshold voltage Th1 but below the threshold voltage Th2 (see FIG. 2) and thus the particles 3 are aligned with the electrical field E (thus, in vertical direction), while the particles 4 still have random orientations.

In FIG. 3C, the voltage V′ is selected below the threshold voltage Th1, and the voltage V is selected above the threshold voltage Th2. Now, both the particles 3 and 4 are aligned in the direction of the electrical field E.

In FIG. 3D, starting from the state of the cell 1 shown in FIG. 3C, the voltage V is changed to below the threshold voltage Th1, and the voltage V′ is changed to above the threshold voltage Th1 but below the threshold voltage Th2 and thus the particles 3 are aligned with the electrical field E′ (thus, extend in the horizontal direction). The particles 4 still keep (at least for some time) their original alignment in the vertical direction, because the voltage V is too low to alter their rotational position.

In FIG. 3E, starting from the non-aligned state shown in FIG. 3A, the voltage V is selected below the threshold voltage Th1, and the voltage V′ is selected above the threshold voltage Th1 but below the threshold voltage Th2 and thus the particles 3 are aligned with the electrical field E′ (thus, extend in horizontal direction), while the particles 4 still have random orientations.

In FIG. 3F, the voltage V is still below the threshold voltage Th1, and the voltage V is increased to above the threshold voltage Th2. Now, both the particles 3 and 4 are aligned in the direction of the electrical field E′.

In FIG. 3G, starting from the state of the cell 1 shown in FIG. 3F, the voltage V′ is changed to below the threshold voltage Th1, and the voltage V is changed to above the threshold voltage Th1 but below the threshold voltage Th2 and thus the particles 3 are aligned with the electrical field E (thus, extend in the vertical direction). The particles 4 still keep (at least for some time) their original alignment in the horizontal direction, because the voltage V′ is too low to alter their rotational position.

FIGS. 3A to 3G show 7 different combinations of orientations of the particles 3 and 4 and thus show 7 different optical states of the cell 1. For example, if the particles 3 reflect blue light, and the particles 4 reflect red light, FIG. 3C shows the most transparent state of the cell 1 (the major part of the incident light is transmitted), and FIG. 3F shows the most reflecting state of the cell 1 (red and blue light is reflected, green light is transmitted or absorbed). The other FIGS. 3 show intermediate optical states.

In another example, the particles 3 absorb blue light and the particles 4 absorb red light. If the light impinging on the cell 1 is white, the color of the light after passing the cell 1 depends on the optical state of the cell. In the state shown in FIG. 3C, white light leaves the cell 1. In the state shown in FIG. 3F, a considerable fraction of the red and blue light is blocked, and green light leaves the cell 1. In the state shown in FIG. 3D, most of the blue light is absorbed, whereas red and green light are allowed to pass. In the state shown in FIG. 3G, most of the red light is absorbed and blue and green light will pass.

Thus, the color of the light leaving the cell 1 can be controlled by supplying different voltages or sequences of voltages V and V′ to the electrodes E1, E2, E3, E4 of the cell 1. Such a cell may advantageously be used in a full color display system. In constructions wherein the change of optical states of the cells 1 can only be achieved at a relatively slow rate, such a full color display may be interesting for applications such as, for example, colored icons, colored billboards, and colored mirrors.

For example only, two types of Micas in dimethylphtalate which may be used as the particles 3 and 4, are Mica111 (Merck) which switches preferably at 0.6V/μm @600 Hz, and Mica205 (Merck) which switches preferably at 1.3V/μm @1 kHz. After mixing both Micas, one can observe that by applying an electrical field E of 0.6V/μm over the mixture only the Mica111 responds to the applied field, whereas after applying 1.3V/μm both Micas respond to the field.

| | | Size (according to | |
|---|---|---|---|
| Mica | Color | Merck) | thickness |
| 111 | rutile fine satin | 1-15 μm | ˜200 nm |
| 205 | Rutile platinum gold | 10-60 μm | ˜600 nm |

FIGS. 4A-4C show a cell construction in which more than two alignment directions of the particles are possible. In all FIGS. 4A-4C, the electro-optical suspended particle cell 1 comprises support members 10, 11 at least one of which is transparent to optical radiation. The liquid 2 is present in-between these support members 10, 11. The electrode E1 is now divided into a plurality of electrodes E1a to E1d which are displaced with respect to each other on the support member 10. The electrode E2 is divided into a plurality of electrodes E2a to E2d which are displaced with respect to each other on the support member 11. The electrodes E1a to E1d are aligned oppositely the electrodes E2a to E2d, respectively.

Furthermore, all neighboring electrodes are separated by a gap 13 to allow insulation between the electrodes. The support members 10, 11 are typically made out of an insulating transparent material. The different shades of the electrodes in the FIGS. 4A-4C indicate different potentials. White corresponds to positively charged, grey corresponds to negatively charged, and black corresponds to neutral. The space between the support members 10, 11 includes a middle layer comprising the suspension medium 2 and two outer passivation layers 14. The suspension medium 2 has a higher dielectric constant than the passivation layers 14. The purpose of the passivation layers 14 is to reduce the inhomogeneity in the electric field in the particle suspension medium 2 of the cell.

By way of example, the particle suspension medium 2 comprises a plurality of anisometric, reflective particles 3 suspended in an insulating fluid. The viscosity of the fluid is selected to permit Brownian motion of the particles but to prevent sedimentation.

Further, all FIGS. 4A-4C show at their right side schematically how the suspended particles 3 are orientated in the cell 1. The particles 3 align perpendicular to the equipotential lines 15.

FIG. 4A shows how to achieve an electric field E perpendicular to the support members 10, 11. A same negative voltage is supplied to all the electrodes E1a to E1d and same positive voltage is supplied to all the electrodes E2a to E2d. The particles 3 will be aligned to extend in the direction perpendicular to the support members 10, 11, resulting in a light transmissive cell 1.

FIG. 4B shows how to generate an electric field E which is directed in parallel with the support members 10, 11, resulting in particles which extend also in parallel with the support members 10, 11 to obtain a non-transmissive cell 1. The electrode E1a and E2a have a negative potential, the electrodes E1b and E2b have a positive potential, and the other electrodes are neutral. This results in equipotential lines 15 largely perpendicular to the support members 10, 11 and thus the electric field E largely in parallel with the support members 10, 11. The gradient of the field lines and the directional inhomogenities occur to a large extend in the passivation layers 14. It is further clear from FIG. 4B that the electric field E extends over a portion of the electro optical medium substantially corresponding to the width of two electrodes. Consequently, four electrodes are required to switch between the transmissive and reflective state.

FIG. 4C shows a configuration of positive and negative electrodes for creating a deflecting cell wherein the particles 3 are aligned slanted with respect to the support members 10, 11. The electrodes E1a, E2a, and E2b have a negative potential while the electrodes E1b, E1c, and E2c have a positive potential. The electrodes E1d and E2d may have a neutral potential. This results in equipotential lines 15 which are slanted with respect to the support members 10, 11. The particles 3 align perpendicular to the equipotential lines 15 resulting in a cell 1 which partly deflects and partly transmits the impinging light.

This approach to obtain particles 3 which are aligned slanted with respect the support members 10, 11 can also be used if the suspension medium 2 comprises two different types of particles 3, 4. By applying the correct electrical field it is possible to slant only one or both the particles 3, 4.

FIG. 5 shows a cell in which the first type of particles absorbs part of the spectrum, and the second type of particles reflect another part of the spectrum. The schematically shown cell comprises two groups of opposing electrodes. The electrodes E1 and E2 generate an electrical field E in the vertical direction, the electrodes E3 and E4 generate an electrical field E′ in the horizontal direction. Although the electrodes E1 to E4 are shown to be single electrodes, the may actually comprise multiple electrodes as shown in FIG. 4. As elucidated with respect to FIG. 4, with such a multiple electrode structure it is further possible to generate a magnetic field E″ which has a non-zero angle with respect to both the electrical fields E and E′.

The cell 1 further comprises relatively large reflecting particles 3 and relatively small absorbing particles 4. In the optical state of the cell 1 shown, the particles 4 are aligned perpendicular to the impinging light beam IB, and the particles 3 have a slanted orientation with respect to the electrodes E1 to E4. If, for example, the particles 3 reflect white light and the particles 4 absorb red light, the cell 1 outputs deflected output light which contains blue and green light.

FIG. 6 shows a matrix of cells forming a light valve being addressed as a matrix display. FIG. 6 shows schematically a top view of a matrix of cells 1 which cover the pixels of a matrix display. The matrix display and it pixels are not shown because they are covered by the matrix of cells 1. The electrodes E1 and E2 extend in different directions. The cells 1 are associated with the intersections of the electrodes E1 and E2. The voltages between the electrodes E1 and E2 are supplied by the driver 5 which receives input data ID.

Alternatively (not shown), the cells may comprise four electrodes E1 to E4 as shown in FIGS. 3 and 5. These four electrodes may be sub-divided in a plurality of electrodes to obtain slanted orientations of the particles, as shown in FIG. 4.

Optionally, the cells may be addressed via a switching element, such as a TFT, diode or MIM device to create an active matrix device.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electro-optical suspended particle cell (1) comprising
a liquid (2) for acting as a suspending medium,
first particles (3) and second particles (4) both being anisometrically shaped and being dispersed in the liquid (2) and having different optical properties,
electrodes (E1, E2) and a driver (5) coupled between the electrodes (E1, E2) for generating an electrical field (E) in said cell (1), wherein
the first particles (3) and the second particles (4) have at least one further different property for obtaining different amounts of rotation of the first particles (3) and the second particles (4) as a function of a strength of the electrical field (E) or as a function of a duration the electrical field (E) is applied.

2. An electro-optical suspended particle cell (1) as claimed in claim 1, wherein the further different property is a dimension, a mass, or a polarizability.

3. An electro-optical suspended particle cell (1) as claimed in claim 1, wherein the electrical field (E) is a static field.

4. An electro-optical suspended particle cell (1) as claimed in claim 1, wherein the electrical field (E) is a homogenous field.

5. An electro-optical suspended particle cell (1) as claimed in claim 1, wherein the driver (5) is arranged for providing at least three different voltage levels (V0, V1, V2) to the electrodes (E1, E2) to obtain a first, second and third static electrical field, respectively, and wherein the first particles (3) and the second particles (4) are selected to obtain three optical states (Tr1, Tr2, Tr3) in dependence on the first, second and third static electrical field:
(i) in the first optical state (Tr1) both the first particles (3) and the second particles (4) are not aligned with the first electrical field,
(ii) in the second optical state (Tr2) only the first particles (3) or only the second particles (4) are aligned with the second electrical field, and
(iii) in the third optical state (Tr3) both the first particles (3) and the second particles (4) are aligned with the third electrical field.

6. An electro-optical suspended particle cell (1) as claimed in claim 1, wherein the electrical field (E) has a first orientation and wherein said cell (1) comprises further electrodes (E3, E4) being arranged for generating a further electrical field (E′) having a second orientation being different from the first orientation.

7. An electro-optical suspended particle cell (1) as claimed in claim 6, wherein the first orientation and the second orientation are mutually perpendicular.

8. An electro-optical suspended particle cell (1) as claimed in claim 1, wherein said cell (1) further comprises first and second support members (10, 11) at least one of which is transparent to optical radiation, the liquid (2) being present between said support members (10, 11), the electrodes (E1, E2) comprising a plurality of first electrodes (E1a to E1d) being displaced with respect to each other on the first support member (10), and a plurality of second electrodes (E2a to E2d) being displaced with respect to each other on the second support member (E2).

9. An electro-optical suspended particle cell (1) as claimed in claim 1, wherein the first particles (2) and the second particles (3) interact with light having different colors either by reflection or absorption.

10. An electro-optical suspended particle cell (1) as claimed in claim 1, wherein the first particles (2) are reflective for a light having a first color, and the second particles (3) are partially or completely absorbing light of a second color different than the first color.

11. An electro-optical suspended particle device (100) comprising a plurality of the electro-optical suspended particle cells (1) as claimed in claim 1.

12. A light valve comprising an electro-optical suspended particle cell (1) as claimed in claim 1.

13. A matrix display comprising a matrix display device (101) and a light valve as claimed in claim 12.

14. A method of operating an electro-optical suspended particle cell (1) comprising a liquid (2) acting as a suspending medium, first particles (3) and second particles (4) both being anisometrically shaped and being dispersed in the liquid (2), and having different optical properties, the method comprises generating an electrical field (E) in said cell (1), wherein the first particles (3) and the second particles (4) have at least one further different property for obtaining different amounts of rotation of the first particles (3) and the second particles (4) as a function of a strength of the electrical field (E) or as a function of a duration the electrical field (E) is applied.

15. A driver for an electro-optical suspended particle cell (1) as claimed in claim 5, wherein the driver (5) is arranged for providing at least three different voltage levels (V0, V1, V2) to the electrodes (E1, E2) to obtain a first, second and third static electrical field, respectively, and wherein the first particles (3) and the second particles (4) are selected to obtain three optical states (Tr1, Tr2, Tr3) in dependence on the first, second and third static electrical field:
(i) in the first optical state (Tr1) both the first particles (3) and the second particles (4) are not aligned with the first electrical field,
(ii) in the second optical state (Tr2) only the first particles (3) or only the second particles (4) are aligned with the second electrical field, and
(iii) in the third optical state (Tr3) both the first particles (3) and the second particles (4) are aligned with the third electrical field.
